(19) United States
(12) Patent Application Publication
(10) Pub. No.: US 2010/0272906 A1
(43) Pub. Date: Oct. 28, 2010

(54) PREPARATION OF WATERPROOF PAPER BOX

(76) Inventor: MENG-THENG WANG, Chunghe City (TW)

Correspondence Address: LEONG C LEI, PMB # 1008, 1867 YGNACIO VALLEY ROAD, WALNUT CREEK, CA, 94598, US

(21) Appl. No.: 12/427,772

(22) Filed: Apr. 22, 2009

(51) Int. Cl. B05D 3/00

(52) U.S. Cl. 427/331

(57) ABSTRACT

A method of preparing a waterproof paper box by: providing a silicon rubber coating material having a viscosity about 15000 to 30000 cps and applying the silicon rubber coating material to the surface of a paper sheet material, and then applying a pressure about 2˜3 kg/cm² to the silicon rubber coating material and the paper sheet material to cause permeation of the silicon rubber coating material into internal fibers of the paper sheet material so that a silicon rubber waterproof film is formed on the surface of the paper sheet material, and then processing the silicon rubber coating material-coated paper sheet material thus obtained into a paper box that has the silicon rubber waterproof film located on the inside.

### BACKGROUND OF THE INVENTION

(a) Technical Field of the Invention

The present invention relates to paper box fabrication technology and more particularly, to the preparation of a waterproof paper box for food grade application.

(b) Description of the Prior Art

Packed instant foods are products of the industrial society following the development of fast pace of life and rise in consumer expenditure on easting out. Cup packed instant needles, bowl-packed instant needles, cup-packed soap are instant foods. Polymers and paper are commonly used for packing instant foods. However, polymer containers are not suitable for holding hot foods because they release toxic substances when over a predetermined temperature. Paper containers do not release any toxic substance when holding a hot food. However, a paper container may absorb water and become soft after water absorption. Therefore, a paper container prepared for holding a liquid food generally has a waterproof film coated on the inner surface. Conventionally, paraffin wax is melted and coated on the inner surface of a paper food container during the fabrication of such a paper food container. However, paraffin wax will be dissolved in hot water over 100° C. When eating an instant food or soup, dissolved paraffin wax will be directly taken into the body, affecting the health of the body.

Further, silicon rubber is a polymer that has a “backbone” of silicon-oxygen linkages. Unlike carbon backbone molecular structure of regular organic carbon compounds, silicon rubber has the molecular structure of “Si—O—Si”. Further, silicon rubber offers good resistance to extreme temperatures, being able to operate normally from −55° C. to +300° C. At the extreme temperatures, the tensile strength, elongation, tear strength and compression set can be far superior to conventional rubbers that are able to operate from −15° C. to +150° C. Bonding nontoxic food grade silicon rubber to the surface of a paper container provides the paper container with an excellent waterproof feature and prevents the paper container from releasing any toxic substances when holding a hot liquid food. Further, silicone rubber is a highly inert material and does not react with most chemicals. Therefore, silicone rubber is practical for glass bonding application. However, it is difficult to bond silicon rubber to a smooth junction surface without holes or within tiny holes. At present, silicon rubber is commonly used in (1) non-structural waterproof gap-filling, and (2) structural bonding between the outer wall of a building and a glass, aluminum or stone sheet material. According to conventional techniques, it is difficult to keep a silicon rubber coating to the surface of a paper material tightly.

### SUMMARY OF THE INVENTION

The primary purpose of the present invention is to provide a waterproof paper box preparation method, which uses a silicon rubber coating to provide a waterproof effect instead of paraffin wax, avoiding eating of toxic substances when the waterproof paper box is used to carry a hot liquid food. It is another object of the present invention to provide a waterproof paper box preparation method, which enables a silicon rubber coating to be fixedly bonded to the surface of a paper sheet being used for processing into a paper box.

To achieve these and other objects of the present invention, a waterproof paper box preparation method includes the steps of: providing a silicon rubber coating material having a viscosity about 15000 to 30000 cps and applying the silicon rubber coating material to the surface of a paper sheet material, and then applying a pressure about 2˜3 kg/cm² to the silicon rubber coating material and the paper sheet material to cause permeation of the silicon rubber coating material into internal fibers of the paper sheet material so that a silicon rubber waterproof film is formed on the surface of the paper sheet material, and then processing the silicon rubber coating material-coated paper sheet material thus obtained into a paper box that has the silicon rubber waterproof film located on the inside.

The silicon rubber coating material is applied to the paper sheet material when the paper sheet material is being transferred through a gap between an applicator cylinder and a sheet-transfer cylinder. At the same time, the applicator cylinder and the sheet-transfer cylinder apply a pressure about 2˜3 kg/cm² to the silicon rubber coating material and the paper sheet material from two opposite sides to cause permeation of the silicon rubber coating material into internal fibers of the paper sheet material so that a silicon rubber waterproof film is formed on the surface of the paper sheet material.

After fabrication of the waterproof paper box, the nontoxic, non-smell, heat resisting, low temperature resisting, wearproof and waterproof characteristic of the silicon rubber coating material allow the waterproof paper box for food grad application.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a waterproof paper box preparation flow chart according to the present invention.

FIG. 2 is a schematic drawing of the present invention, showing a flat paper sheet material transferred through the gap between a sheet-transfer cylinder and an applicator cylinder and coated with a silicon rubber coating material.

FIG. 3 is a schematic drawing of the present invention, showing the silicon rubber coating material permeated into the internal fibers of the flat paper sheet material.

FIG. 4 is a sectional plain view of a waterproof paper box made according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

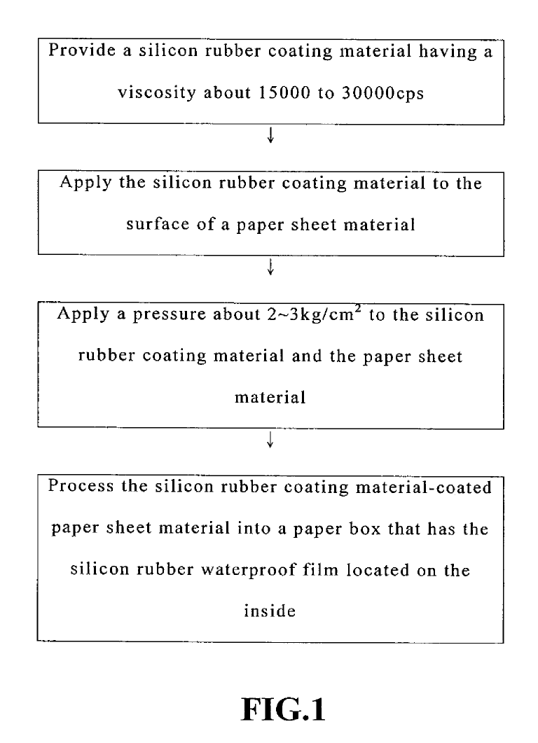

Referring to FIG. 1, the preparation of a waterproof paper box includes the steps of:

a. providing a silicon rubber coating material having a viscosity about 15000 to 30000 cps;

b. applying the silicon rubber coating material to the surface of a paper sheet material;

c. applying a pressure about 2˜3 kg/cm² to the silicon rubber coating material and the paper sheet material to cause permeation of the silicon rubber coating material into the fibers of the paper sheet material so that a silicon rubber waterproof film of thickness about 0.05 mm is formed on the surface of the paper sheet material; and

d. processing the silicon rubber coating material-coated paper sheet material thus obtained into a paper box that has the silicon rubber waterproof film located on the inside thereof.

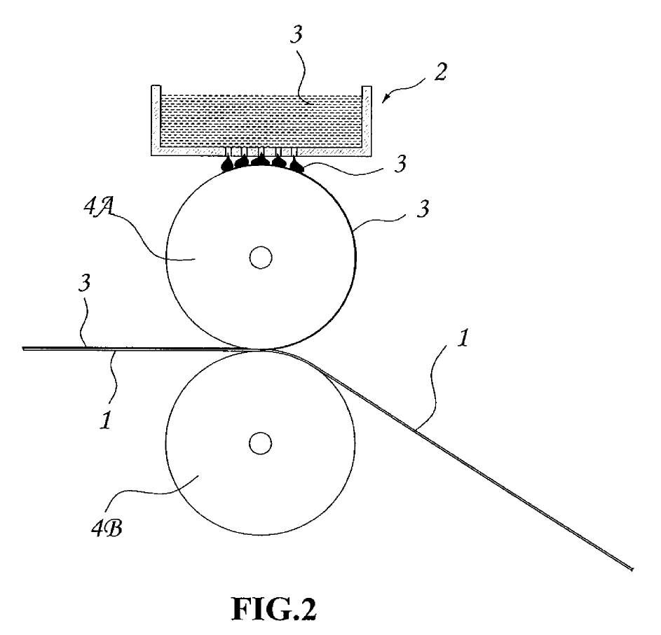

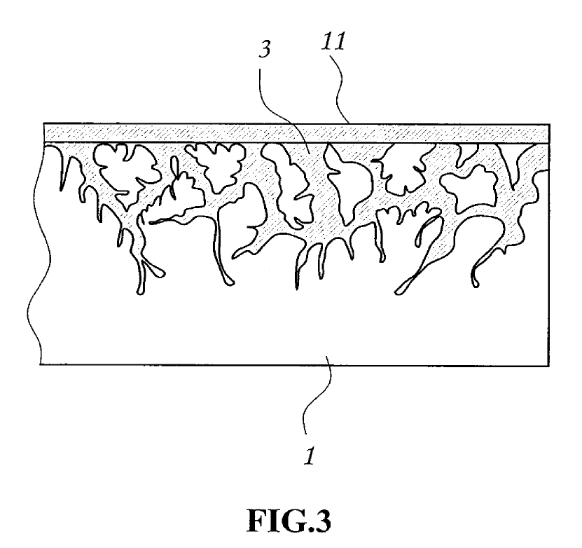

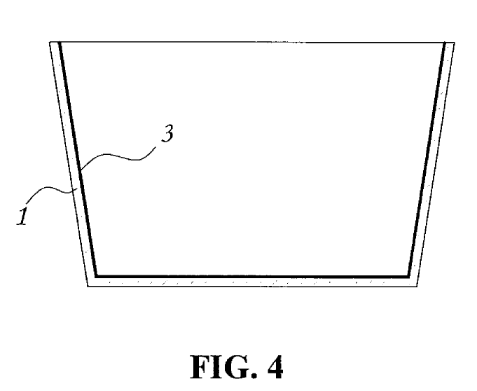

Referring to FIG. 2, a flat paper sheet material 1 is prepared and the bonded with a layer of waterproof film on its one side. By means of transferring the flat paper sheet material 1 through the gap between a sheet-transfer cylinder 4B and an applicator cylinder 4A, a silicon rubber coating material 3 which is carried in a perforated dispensing container of a coater 2 and melted under the operation of a heater (not shown) flows to the periphery of the applicator cylinder 4A in rotation and is transfer-printed by the applicator cylinder 4A onto the surface 11 of the flat paper sheet material 1 (see FIG. 3). Further, heater means is provided inside the sheet-transfer cylinder 4B and the applicator cylinder 4A and operated to keep the silicon rubber coating material 3 that is applied to the periphery of the applicator cylinder 4A melted for printing. When the flat paper sheet material 1 is being transferred through the gap between the sheet-transfer cylinder 4B and the applicator cylinder 4A and coated with the silicon rubber coating material 3, the sheet-transfer cylinder 4B and the applicator cylinder 4A apply a pressure about 2˜3 kg/cm² to the flat paper sheet material 1 from two opposite sides, forcing the silicon rubber coating material 3 to permeate into the internal fibers of the flat paper sheet material 1 (see FIG. 3). When the silicon rubber coating material 3 is hardened, it is tightly boded to the surface of the flat paper sheet material 1. The silicon rubber coating material 3 coated paper sheet material 1 can then be put in a shape-forming mold of a box-forming machine and processed into a box having the silicon rubber coating material located on the inside (see FIG. 4).

Further, the silicon rubber coating material used according to the present invention is prepared from food grade silicon rubber having nontoxic, non-smell, heat resisting, low temperature resisting, wearproof and waterproof characteristics. When a paper box made according to the present invention is used to carry hot liquid food, the waterproof film, i.e., the internal silicon rubber coating does not release any toxic substance. Therefore, a paper box made according to the present invention is suitable for food grade application.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A waterproof paper box preparation method, comprising the steps of:
a. providing a silicon rubber coating material having a viscosity about 15000 to 30000 cps;
b. applying said silicon rubber coating material to the surface of a paper sheet material at one side thereof;
c. applying a pressure about 2˜3 kg/cm² to said silicon rubber coating material and said paper sheet material to cause permeation of said silicon rubber coating material into internal fibers of said paper sheet material so that a silicon rubber waterproof film is formed on the surface of said paper sheet material; and
d. processing the silicon rubber coating material-coated paper sheet material thus obtained into a paper box that has said silicon rubber waterproof film located on the inside thereof.

2. The waterproof paper box preparation method as claimed in claim 1, wherein said waterproof film has a thickness about 0.05 mm.

3. The waterproof paper box preparation method as claimed in claim 1, wherein said pressure about 2˜3 kg/cm² is applied to said silicon rubber coating material and said paper sheet material for a predetermined length of time and released from said silicon rubber coating material and said paper sheet material after bonding of said silicon rubber coating material to internal fibers of said paper sheet material.
